(19) United States
(12) Patent Application Publication
(10) Pub. No.: US 2003/0146260 A1
(43) Pub. Date: Aug. 7, 2003

(54) Method of producing a fastening element to be driven in with a setting tool, a setting tool used with the method, and a fastening element produced by the method

(76) Inventors: Michael Selb, Feldkirch (AT); Karl Flechsig, Traunkirchen (AT)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/353,428

(22) Filed: Jan. 29, 2003

(30) Foreign Application Priority Data
Feb. 7, 2002 (DE) 102 05 031.7

(51) Int. Cl. B25C 1/14

(52) U.S. Cl. 227/10

(57) ABSTRACT

A method of producing fastening elements and which includes placing, in a pin guide of a setting tool, an element having a first, tip-carrying stem section and a second stem section having a hardness lower than that of the first stem section, and forming during a setting process effected by a piston (21) of the setting tool, with the piston, a head (16,16¹) at a free end (15) of the second stem section (13) of the element (10) and having a diameter (17) greater than a diameter (18) of the second stem section, so that a fastening element (19,19¹) is produced, a fastening element produced by the method; and a setting tool for driving a fastening element formed in accordance with the method.

### BACKGROUND OF THE INVENTION

1. Field of the Invention

The present invention relates to a method of producing a fastening element having a tip at one end of its stem and a head at the other opposite end of the stem, to a fastening element produced by the method, and to a setting tool for driving the fastening element in.

2. Description of the Prior Art

Fastening elements such as nails, bolts and the like, which are formed Of steel, are used for fastening objects to hard materials such as concrete, metal, or stone. The fastening elements have a stem, a tip tapering in a setting direction, and a head provided at end of the stem opposite to the tip and having a diameter greater than the stem diameter. As a setting tool for driving a fastening element in, a gas-driven or an explosive powder charge-actuated setting tool is used.

The method of producing fastening elements includes cutting a blank from a wire, forming a tip and, then, a head the edge region of which has a diameter greater than that of the stem. This method, because of a large number of steps, is rather expensive.

German Publication DE-4139653A1 discloses a fastening element, such as a nail, having a stem with a tip and a head provided at opposite ends of the stem. The head is formed of a deformable steel whereas the stem is formed of a high-strength steel deformable within very narrow circumferential limits. Such a fastening element is produced by the above-described method.

An object of the present invention is to provide a method of forming a fastening element having a high-strength stem and an easily formed head.

### SUMMARY OF THE INVENTION

This and other objects of the present invention, which will become apparent hereinafter, are achieved by providing a method including producing, from a wire, an element having a first, tip-carrying stem section having a first hardness, and a second stem section having a second hardness lower than the first hardness. Then, the element is placed in a pin guide of a setting tool, and during a setting process effected by a piston of the setting tool, a head at a free end of the second stem section of the element and having a diameter greater than a diameter of the second stem is formed by the setting tool piston. Thereby a fastening element is produced.

According to the present invention, after the hardening and cooling steps, the produced elements can be packed or placed in a magazine strip and put for sale or shipped to customers or setting tool users. Before the setting process, an element is placed in a pin guide of the setting tool. The head of the element is formed during the setting process by the die section provided at the free end of the setting tool piston.

With the method according to the present invention, during manufacturing of fastening elements, such as nails, bolts, and the like, the final step of forming the head of the fastening elements can be eliminated. The inventive method permits to reduce manufacturing costs of producing fastening elements by more than 10%.

The die section, which is provided at the free end of the piston, has a cavity a shape of which is reversed of that of the fastening element head, with the die cavity forming, during the setting process, the fastening element head.

According to an advantageous embodiment of the present invention, the die section with the die cavity can be releasably connected with the setting tool piston. Providing a releasably connectable die section permits to form fastening elements with heads having different shapes.

According to the present invention, during the first step, the first stem section is subjected to thermal heating, with the element subsequently being cooled with a gas stream flowing past the element. This permits to form a transitional or intermediate section between the first and second stem sections the hardness of which is gradually diminished from the high, first hardness to the lower second hardness. According to the invention, the gas stream flows from the free end of the second stem section in a direction toward the tip of the element.

According to the invention, the length of the second stem section should not exceed the diameter of the second stem section in more than three times.

The method of the invention permits to produce a fastening element having a tip, a first, tip-carrying stem section having a first hardness, a second stem section having a second hardness lower than the first hardness, an intermediate stem section provided between the first and second stem sections and having a hardness that reduces gradually from the first hardness to the second hardness, and a head formed at a free end of the second stem section and having a diameter greater than a diameter of the second stem section.

The provision of the intermediate stem section between the first and second stem sections and with a hardness that gradually diminishes from the hardness of the first stem section to that of the second stem section insures that the element does not break, during the setting process, in the area between the first and second stem sections by acting setting forces. The tests have shown that in an element without an intermediate region between the first, high hardness stem section and the second, low hardness stem section, during a setting process, there is a tendency of the formation of cracks. The formation of cracks is prevented in the fastening element according to the present invention.

Advantageously, the intermediate stem section has a length that amounts at least to 0.15 times of a diameter of the adjoining first stem section.

According to the present invention, the setting direction end of the stem of the setting tool piston is formed as a die section provided with a die cavity having a shape reversed of a shape of the head of the fastening element to-be-driven with the tool. With this setting tool, the head of fastening element is formed during a setting process.

According to a particularly advantageous embodiment of a setting tool according to the present invention, the die section is formed so that it is releasably connected with the setting tool piston. Alternatively, the entire piston can be made replaceable. By using different die sections or pistons, fastening elements with differently shaped heads can be produced. The setting tool can be supplied with a set of pistons or die sections, which would permit a user to form heads of fastening elements with a desired or required shape.

The novel features of the present invention, which are considered as characteristic for the invention, are set forth in the appended claims.

The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a schematic view illustrating a first step of a method according to the present invention for manufacturing fastening elements;

FIG. 2 a schematic view illustrating a second step of a method according to the present invention for manufacturing fastening elements;

FIG. 3 a schematic view illustrating a third step of a method according to the present invention for manufacturing fastening elements;

FIG. 4 a side view of a fastening element after the completion of the third step of the method according to the present invention;

FIG. 5 a cross-sectional view illustrating a position of the fastening element in the pin guide of a setting tool for effecting a fourth step of the method according to the present invention;

FIG. 6 a cross-sectional view illustrating an end of the fourth step performed according to FIG. 5, and the position of the fastening element in a constructional component after the completion of the manufacturing process; and

FIG. 7 a cross-sectional view showing a second embodiment of a fastening element produced according to the present invention.

### DETAILED DESCRIPTION OF THE PREFERRED EMBODIMENTS

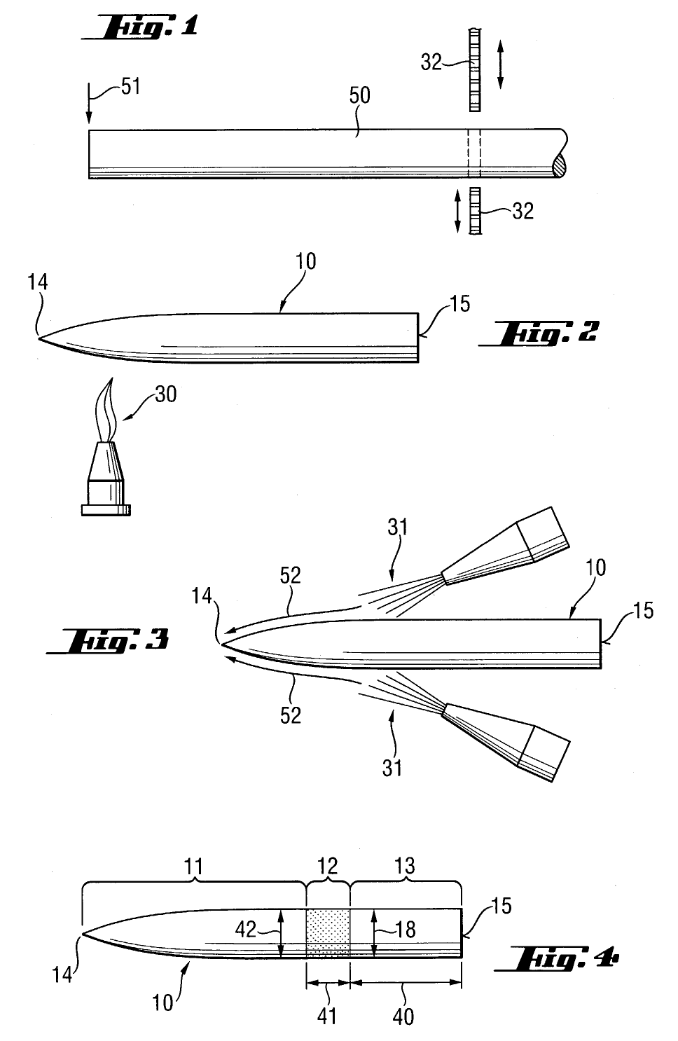

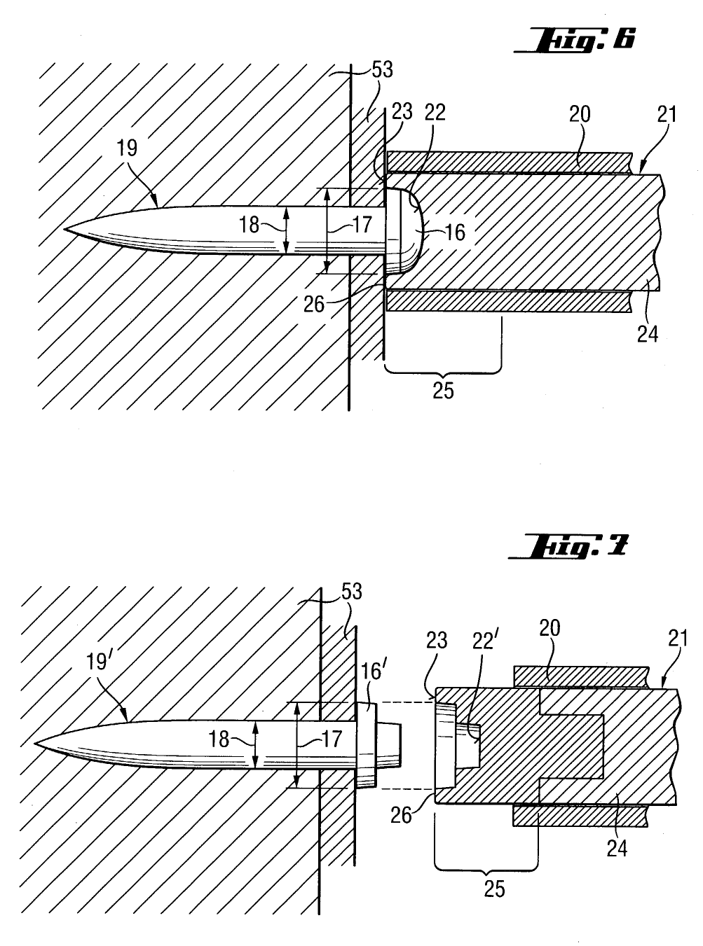

FIGS. 1-6 show the steps of a method of manufacturing fastening elements according to the present invention and a fastening element obtained by the method, with FIGS. 5-6 showing a pin guide of a setting tool for driving fastening elements in, and a setting direction side of a piston stem of a piston used for driving the fastening elements in.

In the first step of the inventive method which is illustrated in FIG. 1, an element 10, which is shown in FIG. 2, is cut-out with cutting elements 32 from a wire 50, e.g., a steel wire. An end (shown with arrow 51) of the element 10 is radially circumferentially deformed for producing a tip 14. The tip 14 can be produced, e.g., by mechanical deformation or by thermal stretching.

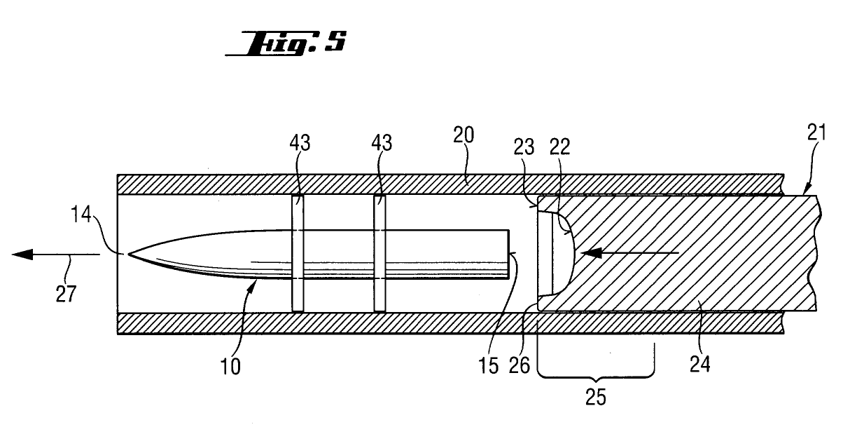

The element 10 is then subjected to high-temperature heating by a source of heat 30, e.g., a flame torch or an inductive heat source (FIG. 2), and is then subjected to continuous cooling with concerted gas stream 31 (FIG. 3). The gas stream 31 flows in a direction indicated by arrows 52 from the rear end of the element 10 to its tip 14.

At the end of the third step, element 10, as shown in FIG. 4, is produced. The element 10 shown in FIG. 4, has a first stem section 11 having a high hardness, and a second stem section 13 having a low hardness. A transitional region 12 is provided between the stem sections 11 and 13. In the transitional region 12, the hardness is gradually reduced from the high hardness to the low hardness. For clarity sake, the transitional region 12 is shown in FIG. 4 with hatching. In the embodiment shown in FIG. 4, the length 40 of the second stem section 13 exceeds the diameter 18 of the second stem section maximum in three times. The length 41 of the transitional stem section 12 amounts to at least 0.15 times of the diameter 42 of the adjoining first stem section 11.

After being formed, fastening elements, such as shown in FIG. 4, can be packed or placed in magazine strips and put for sale. The transformation of the element 10 into a fastening element 19,19¹ is effected only by deformation of the free end 15 of the second stem section 13 in a setting tool, e.g., in a gas, explosive powder charge-actuated, or electropneumatic setting tool.

A fastening element 10, which is shown in FIG. 5, is provided with plastic discs 43 and is placed in a pin guide 20 of a setting tool, which is otherwise not shown. After actuation of the setting tool, the element 10 is driven in a setting direction, shown by arrow 27, in a constructional component (not shown) by a stem 24 of a piston 21. The piston stem 24 has a setting direction end 26 which is formed as a die section 25. The die section 25 has a die cavity 22 and an end surface 23 that forms the end surface of the piston stem 24. The die cavity 22 has a shape reversed of that of a head 16 of a to-be-formed fastening element 19.

As it has already mentioned above, after actuation of the setting tool, the piston 21, together with the piston stem 24, is displaced in the setting direction in the pin guide 20 and drives the element 10 in a constructional component 53 (shown in FIG. 6). During the setting process, a portion of the setting energy is used for deforming the free end 15 of the second stem section 13 of the element 10 into a head 16 with the die section 25. This is possible because the second stem section 13 of the element 10 is formed of a material having a reduced hardness, e.g., of soft steel. The diameter 17 of the head 16, as a result of the deformation of the face end 15 of the second stem section 13 of the element 10, is larger than the diameter 18 of the second stem section 13. It should be pointed out that the second stem section 13 of the element 10 can have a diameter greater than the first stem section 11 of the element 10.

It is to be noted that the die section 25 can be releasably connected with the piston stem 24, as shown in FIG. 7. This insures an easy replacement of the die section 25 with another die section having a different die cavity for forming a differently shaped head of a fastening element.

FIG. 7 shows another embodiment of a fastening element 19¹ which is driven in by the piston stem 24 of the piston 21 into the constructional component 53. In FIG. 7, the piston 21 is pulled back from the fastening element 19¹, which makes the head 16¹ of the fastening element 19¹ clearly visible. The head 16¹ has a different shape than the head 16 shown in FIG. 6. It should be noted that, generally, the head of a fastening element can have any arbitrary shape.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A method of producing a fastening element, comprising the steps of:
producing, from a wire (50), an element (10) having a first, tip-carrying stem section (11) having a first hardness, and a second stem section (13) having a second hardness lower than the first hardness;
placing the element (10) in a pin guide (20) of a setting tool; and
forming, during a setting process effected by a piston (21) of the setting tool, with the piston, a head (16,16¹) at a free end (15) of the second stem section (13) of the element (10) and having a diameter (17) greater than a diameter (18) of the second stem section (13), whereby a fastening element (19,19¹) is produced.

2. A method according to claim 1, wherein the head forming step comprises the step of forming the head (16) with a die cavity (22) provided at an end surface (23) of the piston (21) and having a predetermined shape.

3. A method according to claim 2, wherein the die cavity (22) is provided in a die section (25) releasably connectable with the piston (21).

4. A method according to claim 1, wherein the element producing step comprises the steps of thermal heating of the first stem section (11), and cooling of the element (10) with at least one gas stream (31) flowing past the element (10).

5. A method according to claim 4, wherein the gas stream (31) flows from the free end (15) of the second stem section (13) in a direction toward a tip (14) of the element (10).

6. A method according to claim 1, wherein the element producing step comprises the step of forming the second stem section having a length (40) amounting maximum to three times of a diameter of the second stem section (13).

7. A fastening element, comprising a tip (14); a first, tip-carrying stem section (11) having a first hardness; a second stem section (13) having a second hardness lower than the first hardness; an intermediate stem section (12) provided between the first (11) and second (13) stem section and having a hardness that reduces gradually from the first hardness to the second hardness; and a head (16) which is formed, during a setting process effected by a piston (21) of a setting tool, with the piston at a free end (15) of the second stem section (13) and having a diameter (17) greater than a diameter (18) of the second stem section (13).

8. A fastening element according to claim 7, wherein the intermediate stem section (12) has a length that amounts at least to 0.15 times of a diameter of the adjoining first stem section (11).

9. A setting tool for driving in pin-shaped fastening elements, comprising a pin guide (20); and a piston (21) displaceable in the setting tool and having a stem (24) displaceable, at least temporarily, in the pin guide (20), the piston stem (24) having a setting direction and (26) thereof formed as a die section (26) provided with a die cavity (22,21) having a shape reversed of a shape of a head (16,16¹) of a fastening element (19,19¹) to-be-driven with the setting tool.

10. A setting tool according to claim 9, wherein the die section (25) is releasably connectable with the piston (21).
